(19) United States
(12) Patent Application Publication
(10) Pub. No.: US 2013/0304121 A1
(43) Pub. Date: Nov. 14, 2013

(54) Teething Products

(71) Applicant: Nouri E. Hakim, Monroe, LA (US)

(72) Inventor: Nouri E. Hakim, Monroe, LA (US)

(21) Appl. No.: 13/469,941

(22) Filed: May 11, 2012

(51) Int. Cl. A61J 17/02

(52) U.S. Cl. 606/235

(57) ABSTRACT

Teething products for infants and small children having massaging follicles that contact oral surfaces to soothe and comfort the user.

### FIELD OF THE INVENTION

The present invention relates to teething products, such as pacifiers for children.

### BACKGROUND OF THE INVENTION

The present invention relates to teething products, and more specifically to pacifiers directed to teething infants.

Pacifiers or soothers are widely known and used by parents around the world to calm or pacify their infants or toddlers. The basic principle common to all pacifiers is to have the infant suck on the baglet portion of the pacifier, thereby relaxing and soothing the infant.

For teething infants, pacifiers are sometimes provided with nubs or similar protrusions at one or more locations on the pacifier accessible to the child's gums and/or teeth. Such protrusions help to massage the child's gums, thereby helping to alleviate the pain associated with teething.

The present invention relates to an improvement on such teething products.

### SUMMARY OF THE INVENTION

The present inventions relate to teething aids for use by children. Teething aids are placed on an area of a childrens' product, such that, typically, when the child inserts the product into his/her mouth, the follicles line up with the gums/teeth. The rubbing action occasioned by the child's sucking on the product reduces the discomfort associated with teething.

### BRIEF DESCRIPTION OF THE FIGURES

The details of the present invention will be made clearer by reference to the attached drawings.

FIG. 1 is a perspective view of a pacifier embodying the present invention.

FIG. 2 is a bottom view of the pacifier shown in FIG. 1.

FIG. 3 is a top view of the pacifier shown in FIG. 1.

FIG. 4 is a perspective view of the pacifier of FIG. 1 representing the actual size of the pacifier.

FIG. 5 is a front view of the pacifier shown in FIG. 1.

FIG. 6 is a back view of the pacifier shown in FIG. 1.

FIG. 7 is a side view of the pacifier shown in FIG. 1.

FIG. 8 is a blown-up view of the circled portion of FIG. 7, showing the arrays of follicles in greater detail.

FIG. 9 is a blown-up view of the circled portion of FIG. 8, showing a perspective, detailed view a single follicle.

FIGS. 10 and 13 are a further side view of the pacifier shown in FIG. 1.

FIG. 11 is a blown-up view of the circled portion of FIG. 10, showing the arrays of follicles in greater detail.

FIG. 12 is a blown-up view of the circled portion of FIG. 11, showing a top, detailed view of the follicles.

FIG. 14 is a cross-sectional view of FIG. 13 along the line C-C in FIG. 13, and with FIG. 15 being a blown-up view of the circled portion of FIG. 14, showing the follicles in greater detail.

FIG. 16 is a perspective view of a further embodiment of a pacifier embodying the present invention.

FIG. 17 is a bottom view of the pacifier shown in FIG. 16.

FIG. 18 is a top view of the pacifier shown in FIG. 16.

FIG. 19 is a perspective view of the pacifier of FIG. 16 representing the actual size of the pacifier.

FIG. 20 is a front view of the pacifier shown in FIG. 16.

FIG. 21 is a back view of the pacifier shown in FIG. 16.

FIG. 22 is a side view of the pacifier shown in FIG. 16.

FIG. 23 is a blown-up view of the circled portion of FIG. 22, showing the arrays of follicles in greater detail.

FIG. 24 is a blown-up view of the circled portion of FIG. 23, showing a perspective, detailed view the follicles.

FIGS. 25 and 28 are a further front view of the pacifier shown in FIG. 16.

FIG. 26 is a blown-up view of the circled portion of FIG. 25, showing an array of follicles in greater detail.

FIG. 27 is a blown-up view of the circled portion of FIG. 26, showing a top, detailed view of the follicles.

FIG. 29 is a cross-sectional view of FIG. 28 along the line C-C in FIG. 28, and with FIG. 30 being a blown-up view of the circled portion of FIG. 29, showing the follicles in greater detail.

FIG. 31 is a perspective view of a further embodiment of a pacifier embodying the present invention.

FIG. 32 is a bottom view of the pacifier shown in FIG. 31.

FIG. 33 is a top view of the pacifier shown in FIG. 31.

FIG. 34 is a perspective view of the pacifier of FIG. 31 representing the actual size of the pacifier.

FIG. 35 is a back view of the pacifier shown in FIG. 31.

FIG. 36 is a front view of the pacifier shown in FIG. 31.

FIG. 37 is a side view of the pacifier shown in FIG. 31.

FIG. 38 is a blown-up view of the circled portion of FIG. 37, showing the arrays of follicles in greater detail.

FIG. 39 is a blown-up view of the circled portion of FIG. 38, showing a perspective, detailed view the follicles.

FIGS. 40 and 43 are further front views of the pacifier shown in FIG. 31.

FIG. 41 is a blown-up view of the circled portion of FIG. 40, showing an array of follicles in greater detail.

FIG. 42 is a blown-up view of the circled portion of FIG. 41, showing a top, detailed view of the follicles.

FIG. 44 is a cross-sectional view of FIG. 43 along the line C-C in FIG. 43, and with FIG. 45 being a blown-up view of the circled portion of FIG. 29, showing the follicles in greater detail.

FIG. 46A is a top view of an individual follicle, representing the actual size of the follicle, said follicle being approximately 0.045 inches tall and 0.035 inches wide at its base.

FIG. 46B is blown-up view of FIG. 46A, at 20 times magnification thereof.

FIG. 47A is a top view of a larger individual follicle, representing the actual size of the follicle, said follicle being approximately 0.060 inches tall and 0.040 inches wide at its base.

FIG. 47B is blown-up view of FIG. 47A, at 20 times magnification thereof.

FIG. 48A is a side view of the follicle of FIG. 46A, representing the actual size of the follicle, the view from all sides being the same.

FIG. 48B is a blown-up view of FIG. 48A, at 20 times magnification thereof.

FIG. 49A is a side view of the follicle of FIG. 47A, representing the actual size of the follicle, the view from all sides being the same.

FIG. 49B is a blown-up view of FIG. 49A, at 20 times magnification thereof.

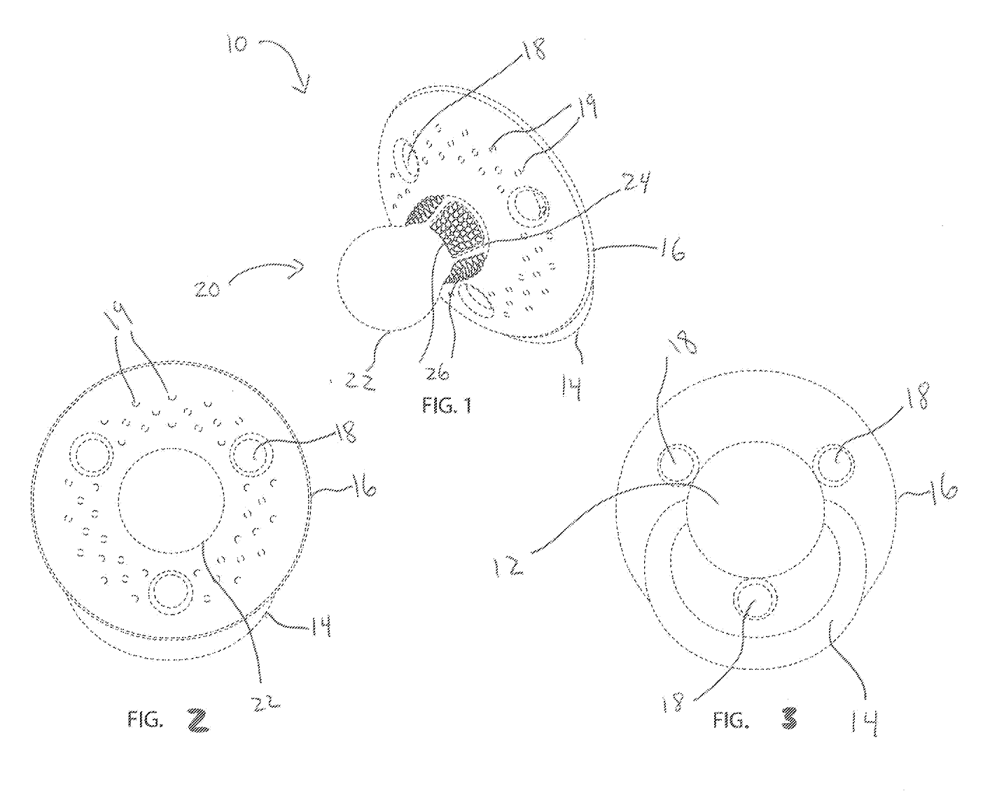

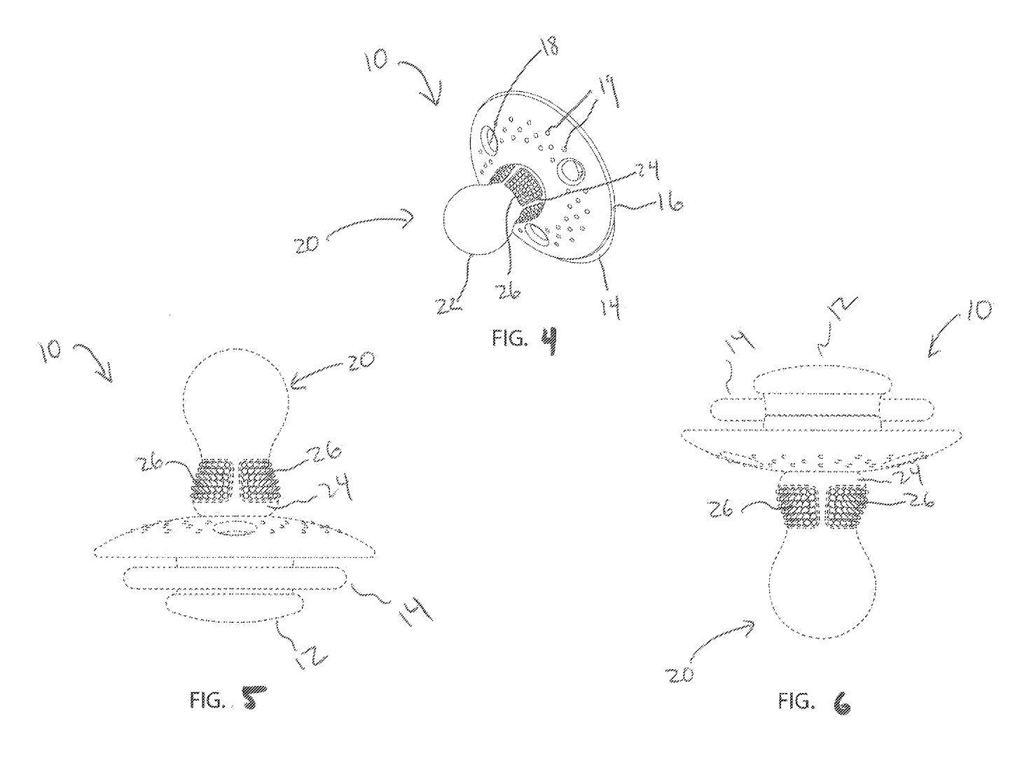

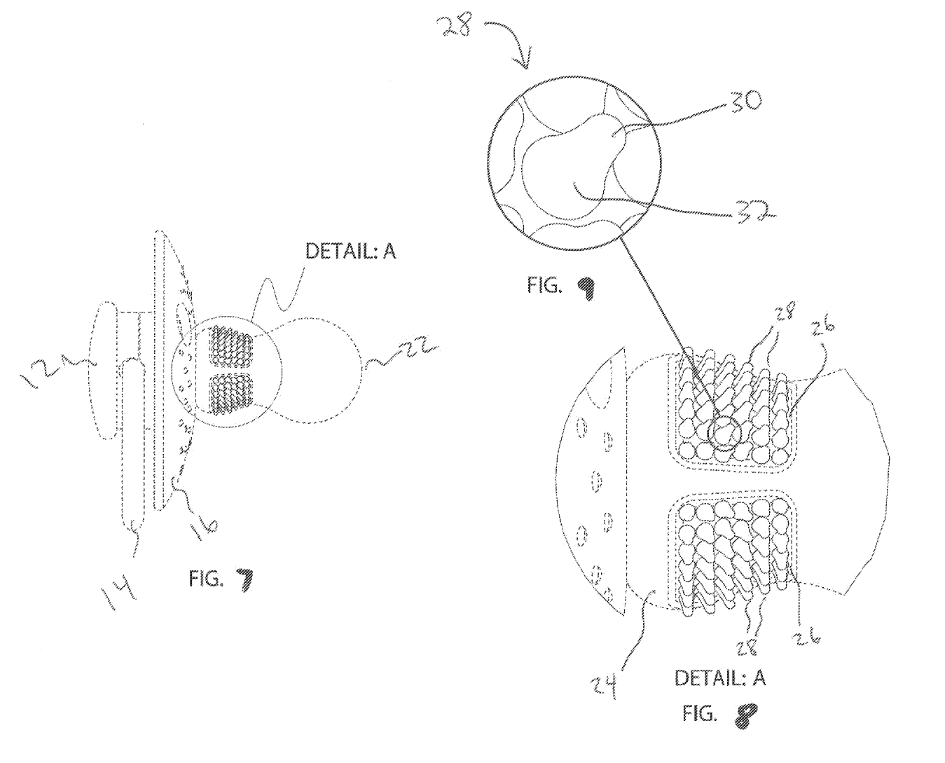

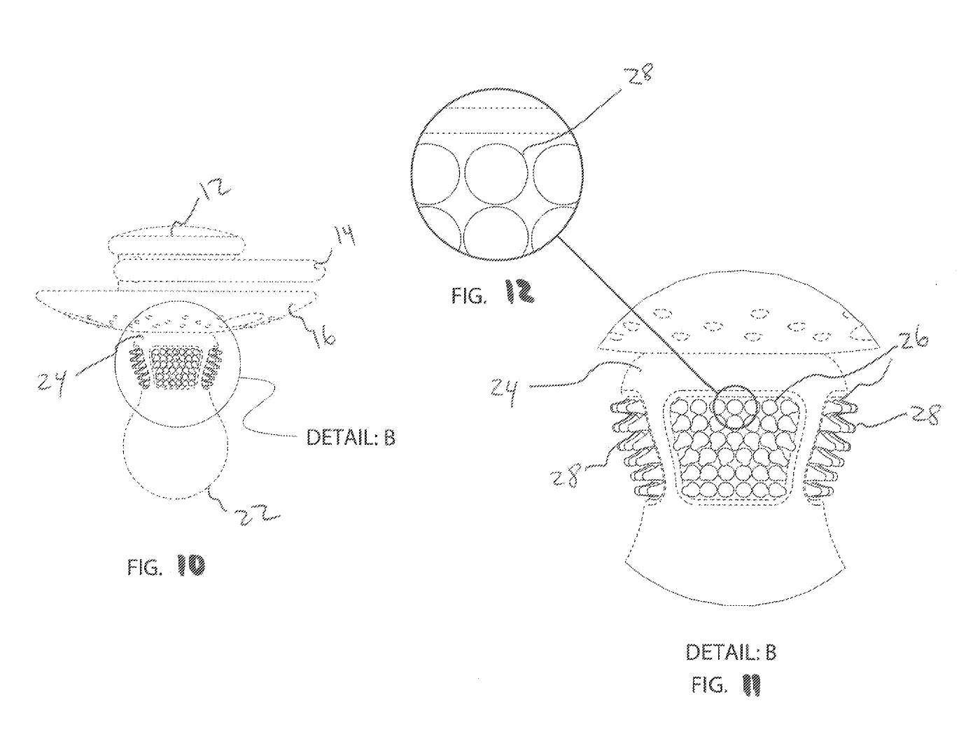

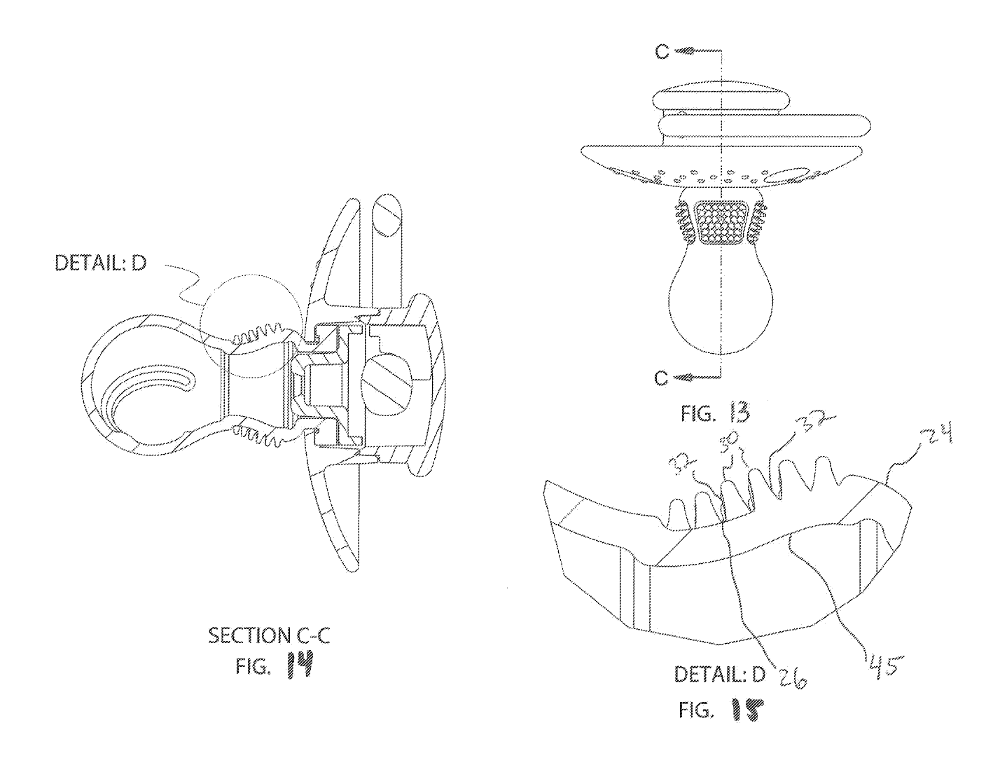

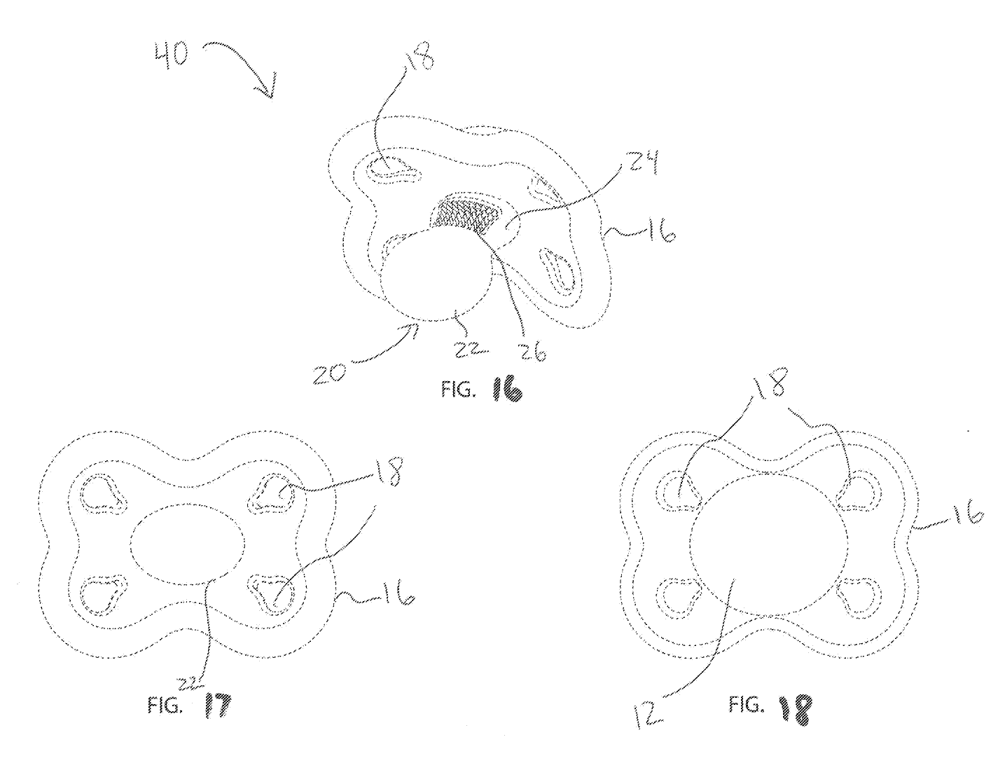

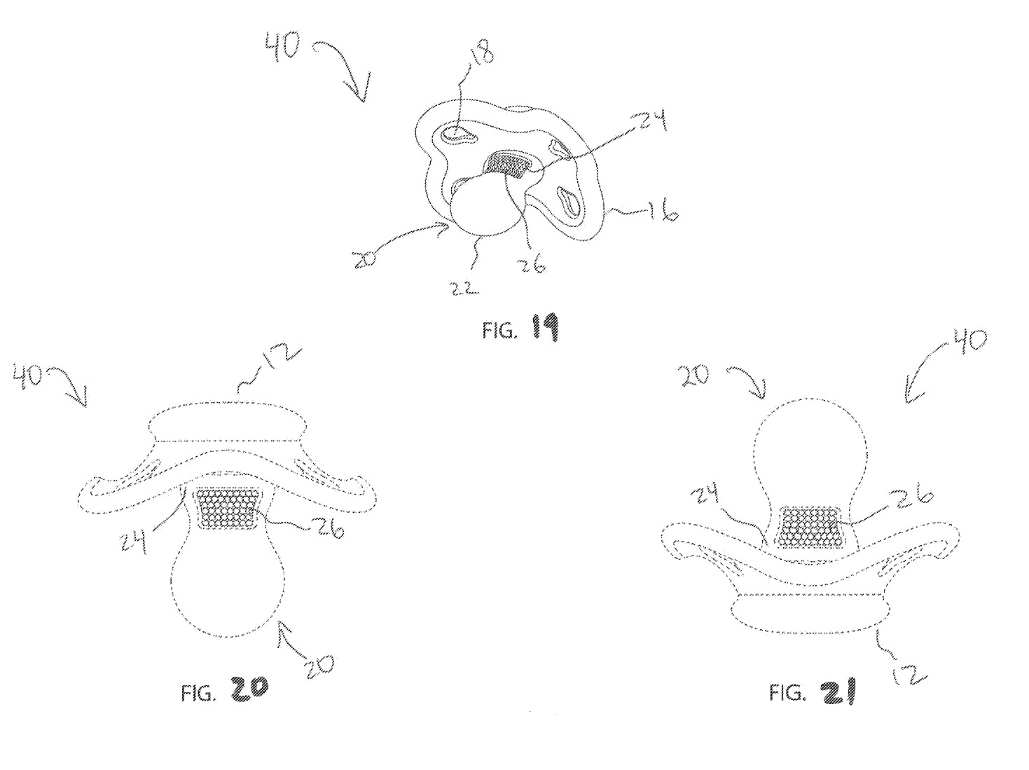

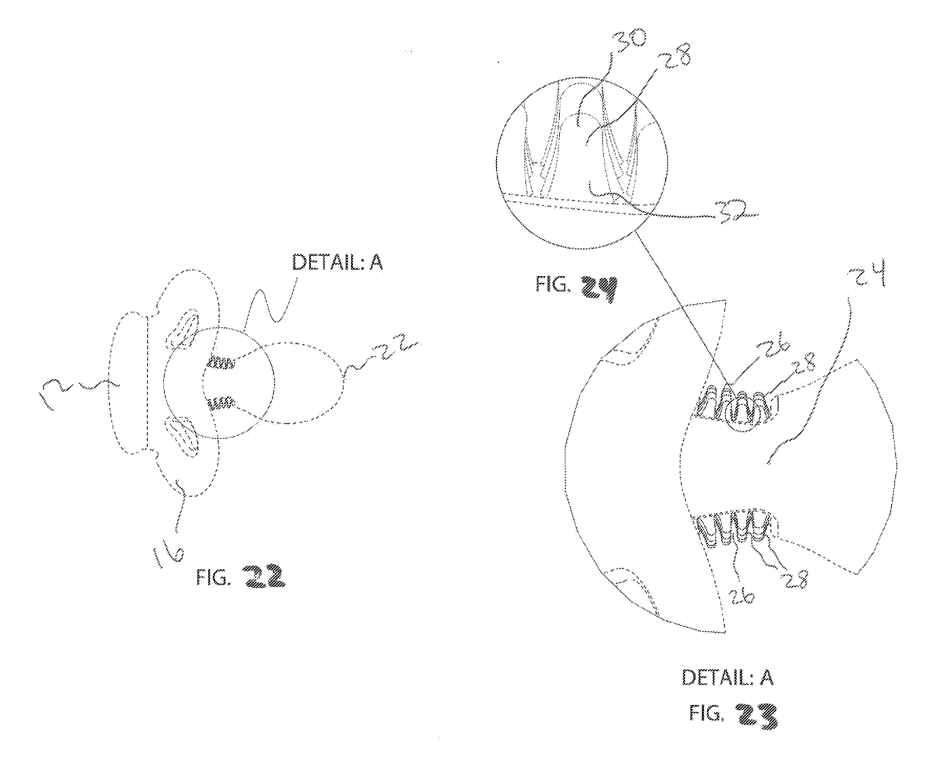

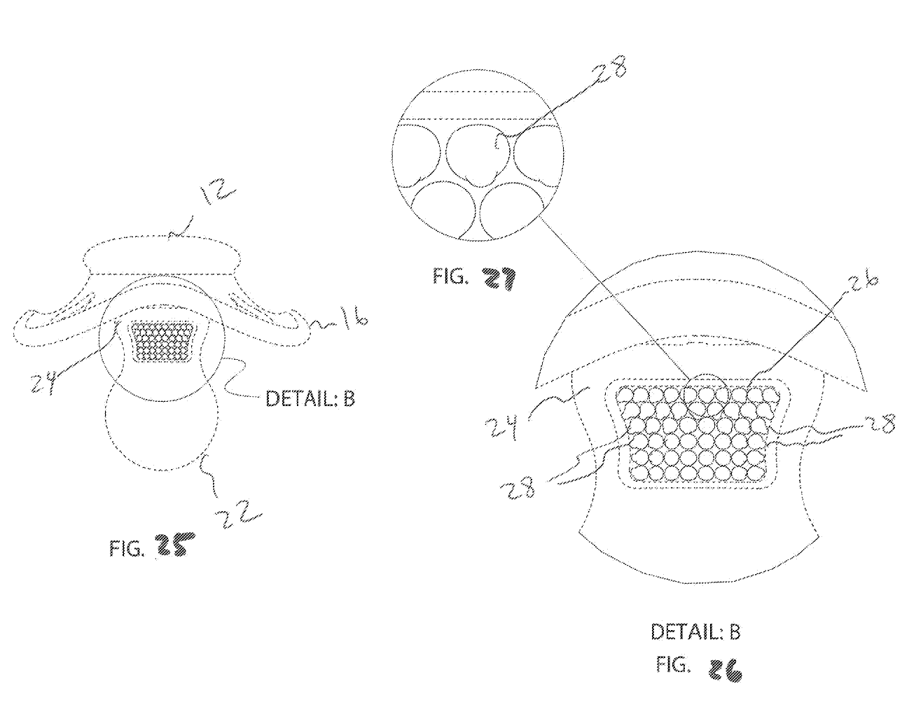

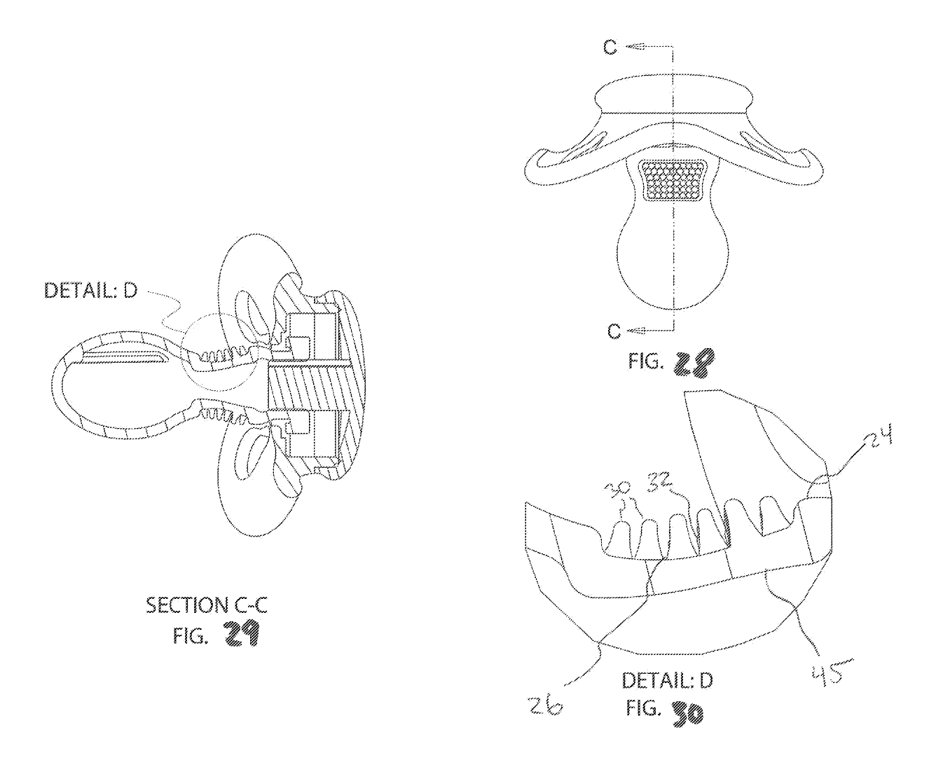

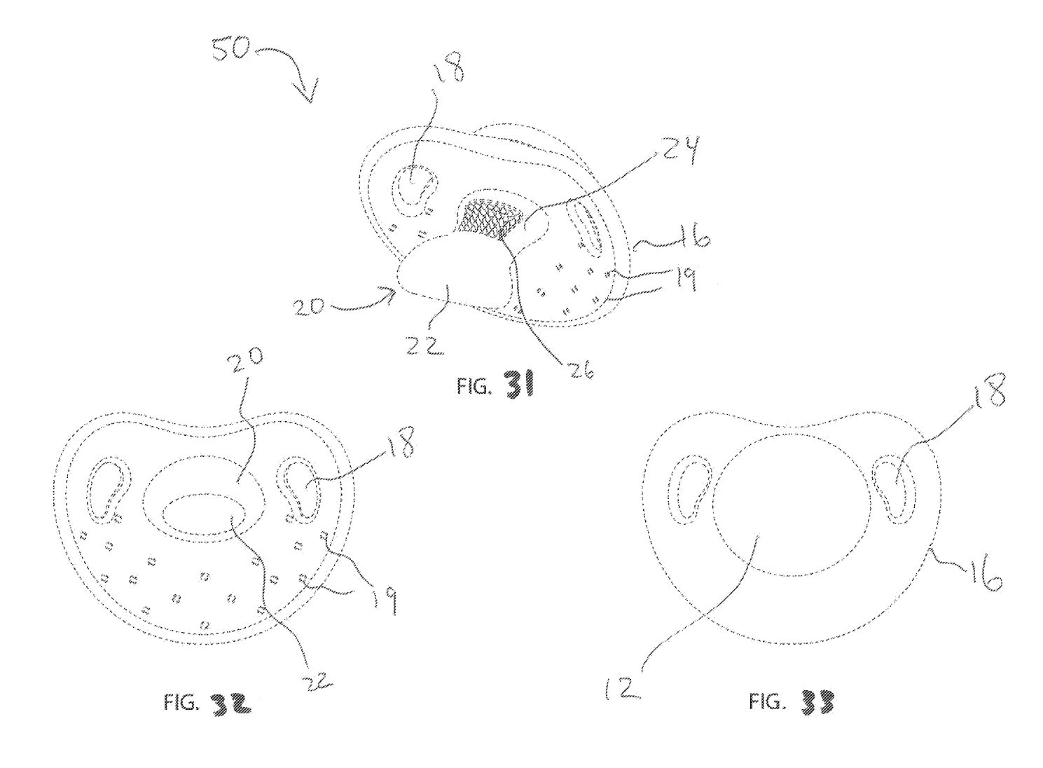

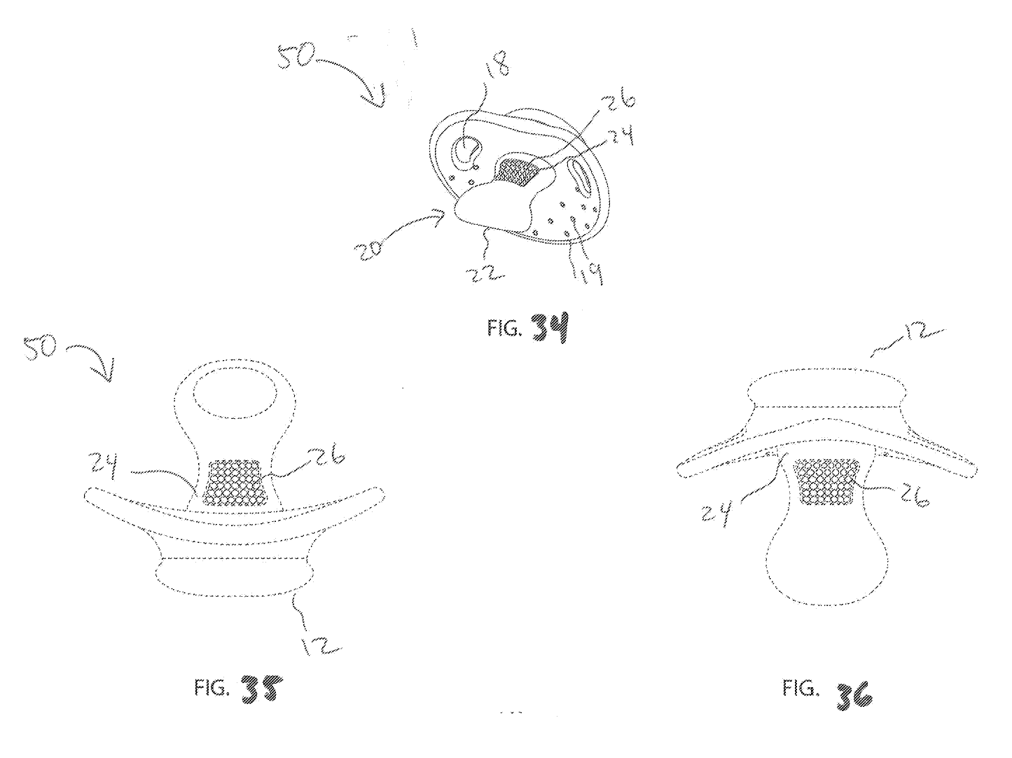

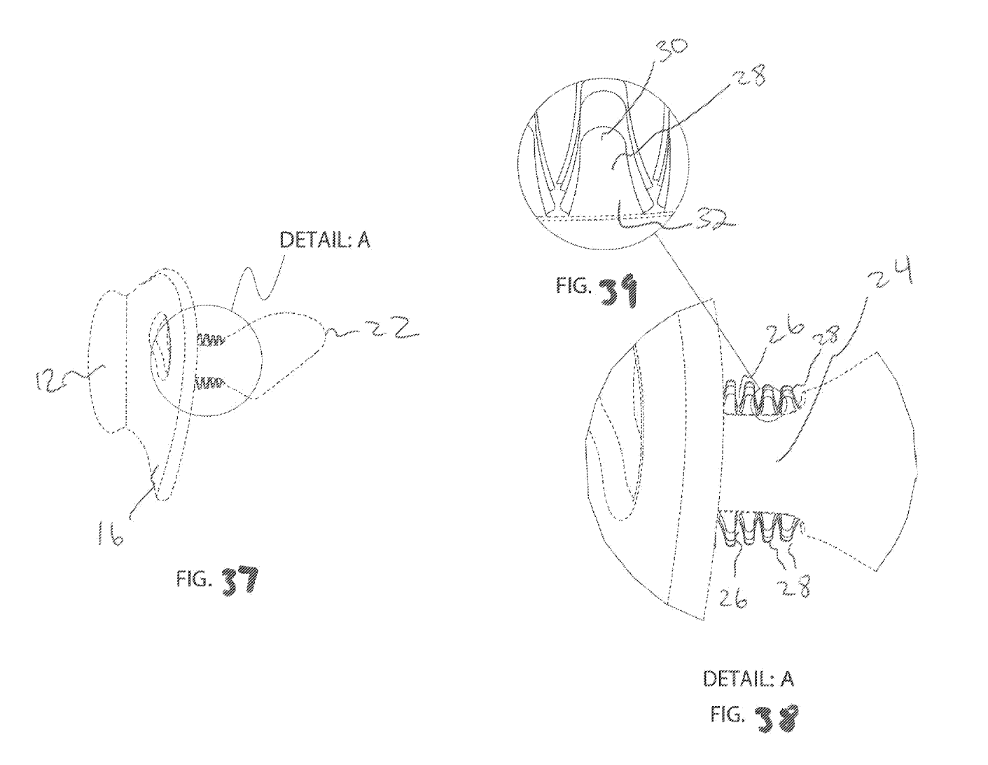

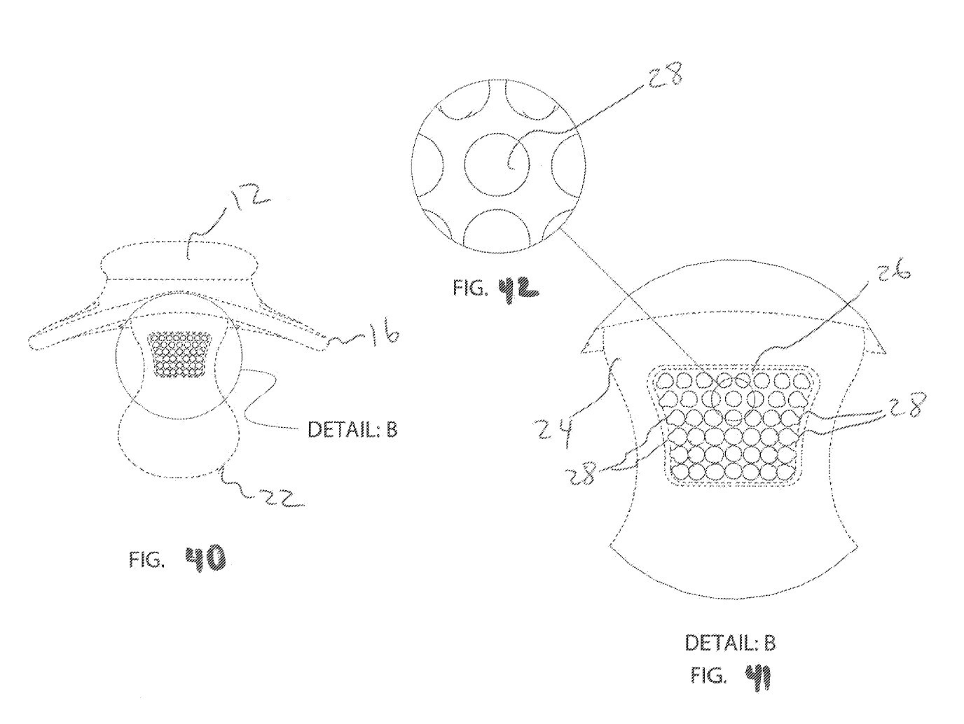

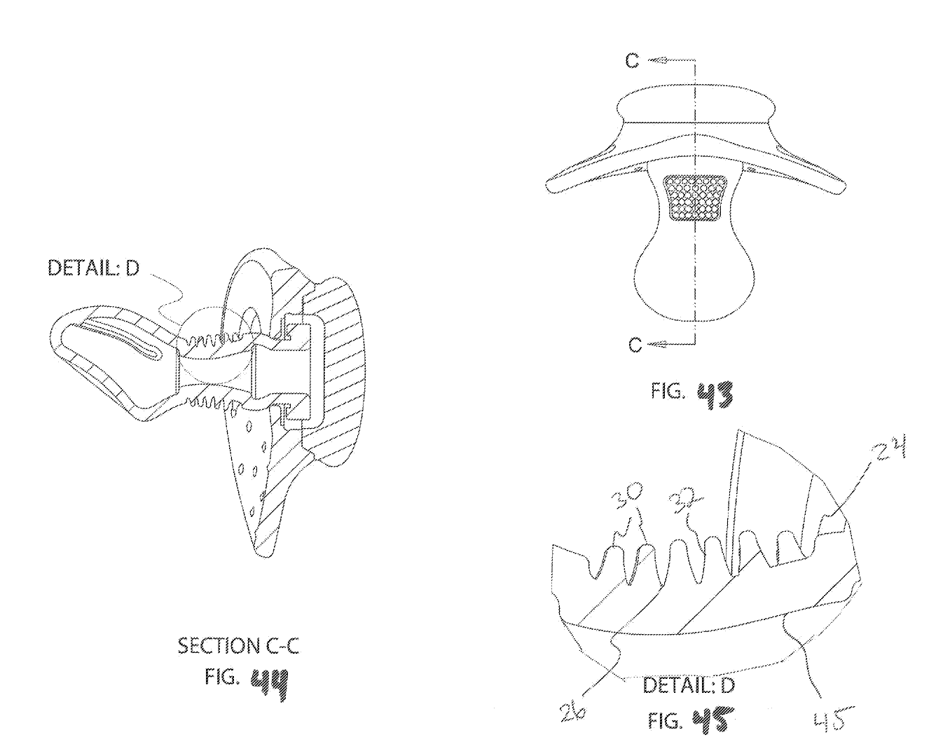

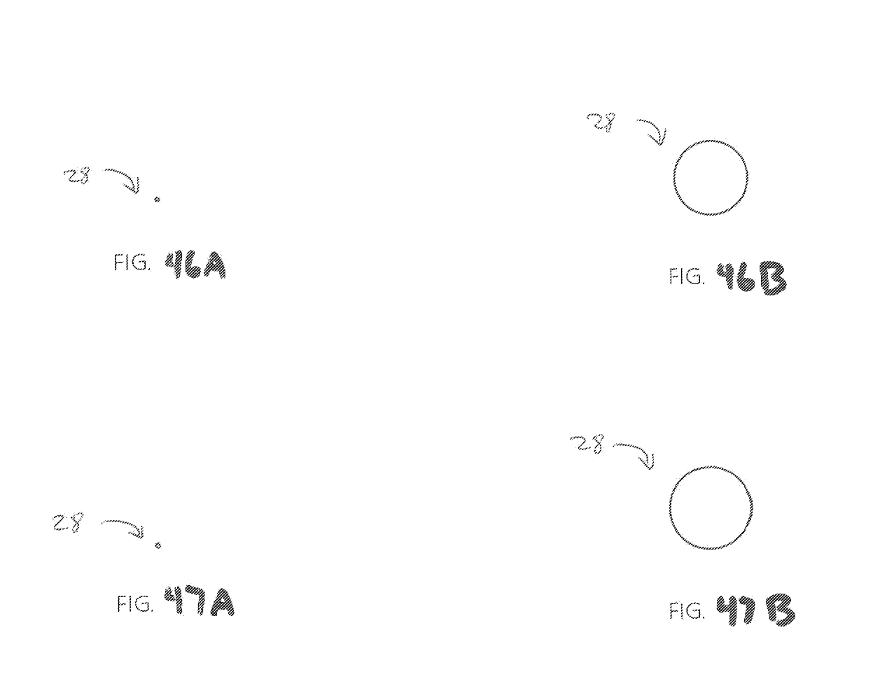

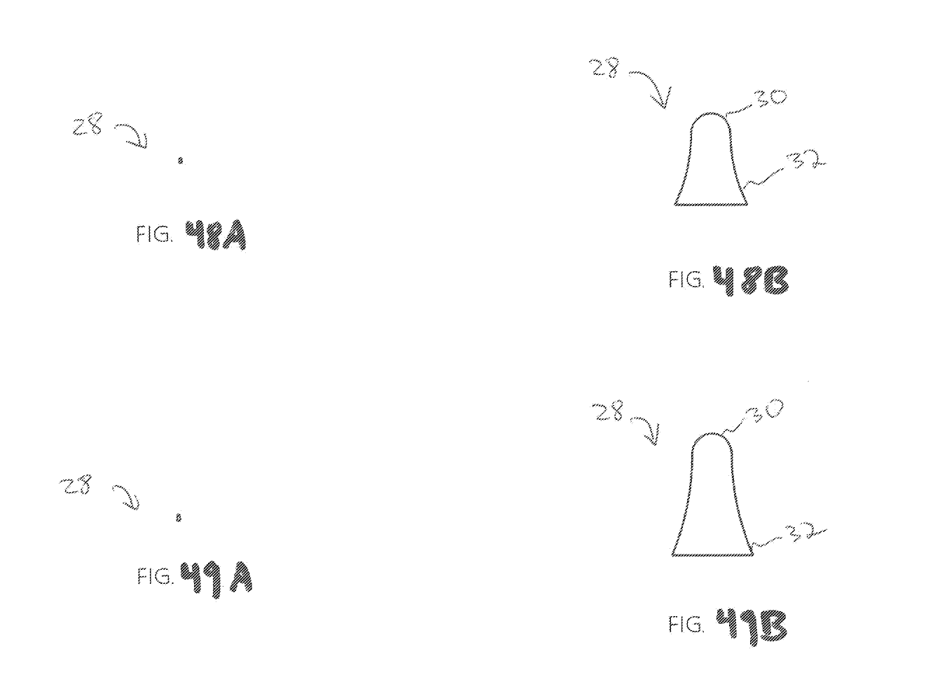

### DETAILED DESCRIPTION OF THE INVENTIONS

The present inventions relate to massaging follicles for use by teething children. The inventions can be adapted to work with a variety of different pacifier baglets, such as spherical, orthodontic, or flattened baglets. A typical baglet has an external portion extending from the shield of a pacifier consisting of two parts—a shaft portion immediately adjacent the shield (also known as the neck of the baglet), and a bulbous portion which is typically wider than the shaft and extends from the shaft (also referred to herein as the head of the baglet). Typically, when an infant inserts the baglet into his/her mouth, the shaft lines up with the gums/teeth. Consequently, teething aids, such as nubs, bumps, or similar protrusions have been placed on the shaft portion to rub against the gums/teeth. The rubbing action occasioned by the infant's sucking the baglet reduces the pain associated with teething.

The present invention relates to a further embodiment of teething pacifier baglet technology, though the invention can be similarly employed in a variety of pacifiers, locations on pacifiers, children's teethers, bottle nipples and so forth.

According to the present invention, arrays of massaging follicles extend from the baglet shaft, though they could likewise extend from any portion of the pacifier or teether that comes in contact with the child's gums. The follicles can be manufactured of any suitable material and be of any durometer. In one embodiment, the follicles are solid, molded in the same molding process as the rest of the baglet, and made of the same material and durometer as the rest of the baglet, the baglet being made from a nontoxic elastomer, such as, but not limited to, silicone (e.g a 50 durometer silicone material for the baglet and follicles). In an alternative embodiment the follicles are made of a different material and/or different durometer material than that of the rest of the baglet. For example, in an alternative embodiment the follicles are made of a higher durometer material than that of the rest of the baglet. A description of multi-hardness baglets, nipples, and the manufacturing processes associated therewith, can be found in U.S. Pat. No. 6,241,110, the specification of which is fully incorporated herein by reference. Examples of durometer hardnesses for the baglet and follicles (and ranges thereof) can be found therein as well (with the same specifications provided for the protrusions or nubs on the baglet being available for the follicles herein).

In one embodiment, each follicle array consists of six rows of follicles, each row consisting of between six and eight follicles. In an alternative embodiment, each follicle array consists of six rows of follicles, each row consisting of between eight and ten follicles. In additional alternative embodiments, more or less rows and/or follicles per row can be provided. In one embodiment the number of follicles per row is constant. In an alternative embodiment, the number of follicles per row increases in rows closer to the shield and farther from the bulbous portion for aesthetic purposes.

In one embodiment, each array consists of at least 50 follicles per square inch. In a further embodiment, each array consists of at least 100 follicles per square inch. In a further embodiment, each array consists of at least 200 follicles per square inch. In a further embodiment, each array consists of at least 300 follicles per square inch. In a further embodiment, each array consists of at least 500 follicles per square inch. In a further embodiment, each array consists of 500-600 follicles per square inch. In a further embodiment, each array consists of at least 1000 follicles per square inch. In a further embodiment, each array consists of at least 2000 follicles per square inch. Any further variation of number of follicles per square inch can be provided consistent with the invention.

In one embodiment, there is a total of four arrays, each array extending from a section of the baglet that is recessed slightly for aesthetic purposes. In this embodiment, to maintain a uniform thickness of the baglet wall throughout, the inner wall of the baglet is correspondingly recessed. In alternative embodiments, more or less arrays can be provided. A constant amount of space can be provided between each array, or a variable amount of space can be provided between different arrays. In a further alternative embodiment, only one array of follicles is provided, which extends completely around the shaft of the pacifier.

In one embodiment, the follicles are approximately cone-shaped, the base of the cone nested in the baglet wall, and the follicles extending approximately perpendicularly from the baglet wall. Due to the curvature of the wall of the baglet shaft, the follicles point in different directions depending on the contour of the baglet wall at the location from which each follicle extends. Follicles oriented in different directions can increase the surface area of contact between the follicles and the child's gums, making it easier for the follicles to reach the tops and sides of the gums. The tips of the follicles are rounded or spherical.

The follicles need not be cone-shaped. For example, in an alternative embodiment the follicles are cylindrical. In a further alternative embodiment, the follicles are hemispherical.

Likewise, the follicles need not be rounded at the tip. In a further alternative embodiment, the follicles are flat at the tip. In a further alternate embodiment, the follicles are frusto-conical. In yet a further alternative embodiment, the follicles are pointed at the tip.

In one embodiment, the follicles are all uniform in shape. In alternative embodiments, variation is provided in the shape of the follicles. For example, a mixture for the shapes and/or their tips of the follicles can be provided.

In one embodiment, the follicles are all uniform in size. In a further embodiment, the follicle vary in their sizes. For example, in one embodiment, are taller in the middle rows of the arrays, and smaller towards the edges of the arrays. In one variation of this embodiment, the follicles range from 0.035 inches to 0.60 inches in height, and their bases range from 0.035 inches to 0.045 inches in thickness. In this variation, the tips of the follicles are 0.020 inches in diameter. The variation in follicle height within a given array of follicles is for aesthetic reasons, giving the follicles a flowing or wave-like appearance.

Each aspect of the pacifier can have any desired degree of transparency or opacity. That is, each aspect of the pacifier shield, the follicles, and any other part, may be transparent, translucent, or opaque, including any desired coloring. For example, in one embodiment, the follicles and the pacifier shield are both transparent. In an alternative embodiment, the follicles are not transparent but the pacifier shield is, or vice versa. In further alternative embodiments, any additional variation can be made with respect to the transparency of some parts of the pacifier but not others. For example, some follicles can be made transparent but not others. In further alternative embodiments, the pacifier shield, the follicles as a whole, and/or individual follicles can be colored in any desired color, with any desired combination of transparency, opacity, and/or coloring desired.

Baglets typically come in different sizes, depending on the size/age of the user. Baglets with larger shaft portions can generally accommodate more follicles than smaller baglets. Follicle arrays can be of various different sizes and shapes (e.g., trapezoidal, oval, oblong, circular, triangular, etc.), spanning portions of the baglet or pacifier, or entirely surrounding the baglet or portions thereof. Follicle arrays can be situated on the top of the baglet shaft, the bottom of the baglet shaft, one or more sides of the baglet shaft, or a combination thereof. Arrays can have any number of follicles and any number of follicles per unit area. Alternatively, follicles can be placed on the pacifier on an individual basis rather than part of an array.

In one embodiment, the follicles are flexible and undulate as the child sucks on the baglet, massaging the child's gums and providing relief from the pain associated with teething. In a further embodiment, the follicles are relatively rigid and the child's sucking motion creates a massaging affect as the follicles rub against the child's gums.

With reference to the Figures, pacifiers 10, 40, and 50 can comprise shield 16, cap 12, handle/ring 14, and baglet 22. Shield 16 comprises air holes 18, and bumps or protrusions 19. Baglet 20 comprises shaft portion 24 and bulbous portion (head) 22. Extending from the shaft portion 24 of baglet 20 are one or more arrays 26 of follicles 28.

Follicles 28 have a conical base portion 32 and spherical or rounded tip portion 30. The follicles 28 are taller in the middle rows of arrays 26, with rows being oriented substantially perpendicular to the direction of insertion of the baglet into the child's mouth. The outer wall of baglet shaft portion 24 is recessed somewhat to accommodate the protruding follicles 18. The inner wall 45 of the shaft portion 24 of the baglet is correspondingly recessed resulting in a uniform thickness of the baglet wall.

The above description and drawings are considered that of certain embodiments of the present inventions only. It will be understood that the embodiments shown in the drawings are for illustrative purposes only and are not intended to limit the inventions' scope. Modifications of the inventions and applications of the inventions, including, but not limited to, the size, number, shape, material, placement and orientation used for the follicles, will occur to those skilled in the art and to those who make or use the inventions. It will also be apparent that while certain aspects of the inventions described herein may be related to the way that the device works, others aspects are provided for aesthetic purposes to create a desired appearance. The present inventor reserves all rights to pursue both utility patent and design patent protection to the various aspects of his invention described herein.

What is claimed is:

1. A device for relieving the pain of teething comprising at least one protrusion, said protrusion being capable of undulating back and forth in response to a sucking motion.
